(19) United States
(12) Patent Application Publication
(10) Pub. No.: US 2005/0010575 A1
(43) Pub. Date: Jan. 13, 2005

(54) Transactional processing system

(76) Inventor: Arthur Pennington, Buffalo Grove, IL (US)

Correspondence Address: VEDDER PRICE KAUFMAN & KAMMHOLZ, 222 N. LASALLE STREET, CHICAGO, IL, 60601, US

(21) Appl. No.: 10/615,958

(22) Filed: Jul. 9, 2003

(51) Int. Cl. G06F 7/00

(52) U.S. Cl. 707/100

(57) ABSTRACT

A system provides self-generated documents which may include statements, summaries, reports, and transactions and the system conducts transactions conforming to the documents. The system includes a Designer responsive to operator input instructions to generate computer-like control commands to a server which, in turn, generates commands for controlling a computer. The system depends in part on pre-stored data which establishes parameters in which the transaction may be carried out. Using the pre-stored data, in conjunction with the generated documents, completed forms may be generated and thereupon allowing a final report to be automatically generated. The report may thereupon be displayed to an end user.

### FIELD OF THE INVENTION

This invention relates to computer driven business administration systems for processing transactional information and more particularly to such systems having built in self-programming capabilities.

### BACKGROUND

Currently, business customers such as financial services (insurance, banking, mutual funds) are paper intensive and highly regulated. An important differentiator for such businesses are “price” and the “level of service” that can be provided. Both of these differentiators are inherently dependent on the limitations of the computer systems that are used.

For convenience of expression the term “Business” is used hereinafter to mean any suitable business, mutual fund, insurance company, bank, organization, financial entity, and the like, which the invention may serve.

Traditionally, the administration of business accounts has been a costly and complicated process which requires a time consuming process of setting up new computerized administration systems within the business administration structures. The costs for designing and setting up these new systems may range from $100,000 to several million dollars. It may require weeks to months and sometimes even years to completely implement these new systems.

These administration systems are mission-critical applications with a long life cycle. As a result, business accounts are still being administered on systems designed and first implemented perhaps thirty to forty years ago. When these existing systems were designed, the technical and business environment was primitive by today's standards. They usually had the following limitations: computing power and disk storage were extremely expensive; there were few, if any, software tools available to enable a quick development of new application logic; there were few or no software tools available to form and support document-based processes; there were little or no infrastructure or standards for electronic communication between companies and their customers, sales force, and suppliers; and product features and distribution channels were relatively static and primitive by today's standards.

Today, administration systems are dynamically changing almost every year. The cost of computing power and disk storage is insignificant as compared to the cost of the technicians required to customize and implement system modifications. The software industry has produced tools that greatly speed the delivery of the complex logic needed to administer financial service. A secure internet, VPNs, and intranets provide a physical mechanism for expedited communication.

A recent innovation is low cost of computing power, combined with easy to use software tools, which enables a development of systems that handle all of the pertinent business processes, rules, and calculations associated with a given transaction. An innovation is the available low cost of disk storage which thereby enables the design of systems to store all pertinent data in a user friendly format and software tools that enable complex calculations and administrative rules that allow customization of the system by knowledgeable users, without requiring programmers, thereby speeding the time to market for new products. Furthermore, business administration systems support document-based processes, enabling a customer to fill out a transaction request which the system processes and returns an updated document to the customer, confirming the transaction and reflecting the current state of the customer's account. Also, the standards for electronic communication enable a streamlining of administrative functions to be done by the person responsible for the customer account or the customer himself and databases today, providing a flexible and extensible management of information.

Therefore, these recent innovations in computerized technology reduce the need for manual processing and training by providing an opportunity to construct improved financial administration systems. As such, there exists a need for a transactional processing system utilizing the currently available technology advantages to improve business administrative systems.

### SUMMARY OF THE INVENTION

One aspect of the present invention allows a person or user with no special training in programming to design new business programs, especially in the field of financial transactions. This is done by the use of a Designer and a server. The user feeds user input instructions into the Designer, which creates forms, summaries, and systems for implementing, editing, calculating, and arranging work flow rules. The output of the Designer is fed into the server which already pre-stores information in memory data fields. Responsive to the commands in the output received from the Designer circuit, the server combines the Designer supplied information with information pre-stored in the server memory data field to create the necessary forms and other documents that are supplied to customers and other end users. The created document may be sent over the internet, printed, archived on a CD, or any other suitable storage or transmission medium.

### BRIEF DESCRIPTION OF THE DRAWING

The invention will be understood best from a study of the following description taken with the attached drawings:

FIG. 1 illustrates a block diagram of the processing architecture of the present invention; and

FIG. 2 illustrates a flowchart of steps of one embodiment of the present invention.

### DETAILED DESCRIPTION OF THE INVENTION

Generally, the present invention is a business administration software tool incorporating a Designer and a server which provide flexibility and ease of use with limited built-in constraints. A database starts with an industry standard and may be modified almost without restriction. A system-to-user interface allows for any reasonable form of input and output that is directly useable. Every request and document otherwise referred hereinafter as a transaction, is processed independently and immediately or, it can be scheduled for processing at a predicted time in the future, or when processing time is available.

The Designer

In accordance with the present invention, the “Designer” is an online production creation tool useable by a business knowledgeable person with either minimal or almost no technical assistance. Responsive to human input, the Designer defines documents, transactions, edits, calculations and data required to perform a series of business functions.

The human input, otherwise referred to as user input, is provided in a program suitable for spreadsheets such as Excel, available from Microsoft, Redmond, Wash. For example, the Designer, in response to the business knowledgeable person's instructions, might create a new charge process by providing a withdrawal confirmation document, including the calculations associated with a withdrawal charge. Once described, the new calculations are “dragged” onto the withdrawal transaction confirmation document, and thus automatically implemented in the future.

For each document associated with the product, in one embodiment, the Designer: identifies the document template and any pre-existing document formats, such as “Microsoft Word” document or “PDF” document that contains the text of the document; identifies the document as a transaction request form, or a transaction confirmation document; identifies the transactions supported by the document, preferably, selected from an industry standard list; or a new transaction that can be created immediately; identifies business and edit rules associated with the document and rules for scheduling future events upon successful completion of this document; and creates and arranges the variable data fields in their proper place on the document. The Designer operates in response to a first set of software instructions for performing the above-noted operations, as the software instructions provide for application-specific implementation of each operation.

For each field associated with each document, the Designer: identifies the source and indicates whether the field is input by the user, calculated by the system, taken from the database, or obtained from some other document or a site on the Internet; characterizes the display of this field; identifies the calculation required by the data field, preferably in a spreadsheet format; for input fields, identifies the default value and makes any calculations and edits associated with the field, indicating the severity of an error; and for fields obtained from another document or website, identifies the URL and the path through the URL which is used to obtain the field.

When the above steps are completed for a document, the Designer validates the document against industry standards for the transactions. For example, a life insurance product designed by the inventive system might implement a new withdrawal charge by describing a withdrawal, a form of calculation, and a charge field dedicated to that withdrawal. In one embodiment, automated testing is also a built in feature of the Designer.

The Designer requires only the detailed data concerning the product being implemented, without traditional programming. Once a product is defined, it can be easily cloned for use in creating another product, saving substantial time in the process. Hence, the use of the Designer enables new products to be implemented by a reduced amount of personnel in hours, instead of prior art techniques which required, perhaps, weeks, months or longer.

The Server

The server is any suitable processing environment, such as one or more processors executing operating instructions. The server provides an operational environment which actually performs the functions created by and responsive to the Designer. It enables an entry of data (through a document request form), editing transaction, and making calculations, as required. The server produces data for an output document giving the results of the transaction, and the scheduling of any future automatic transactions that may be necessary. The database is updated, as required, during this process.

The server supports and includes the following business functions: retrieval and display of customer account and personal information; entry of financial and non-financial transactions; real time processing of all transactions; time driven processing (future scheduled transactions); production of documents, statements, and other related customer communications; generation of accounting, commissions, and other financial related information; and interfaces with other systems and organizations, as required. The server operates in response to a second set of software instructions providing for execution of the above-noted operations.

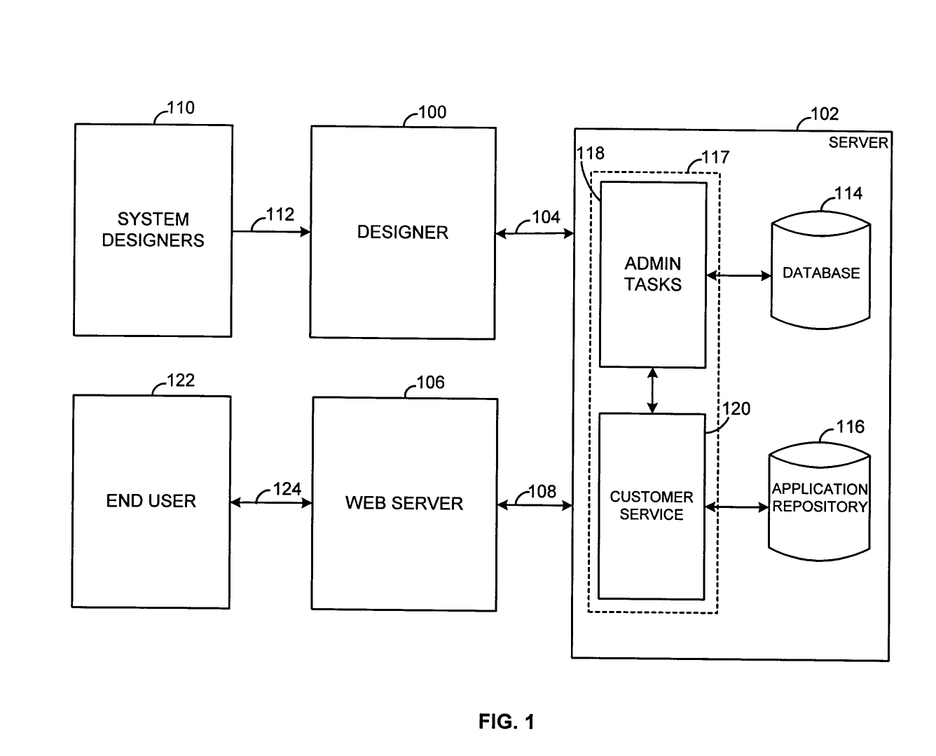

More specifically, FIG. 1 shows the architecture of the inventive system which includes Designer 100 and a server 102 that are interconnected via any suitable means, such as two-way data highways which may, in one embodiment, be either hard wired or utilize a software created path 104. The Designer 100 may be installed in a “Microsoft Office” or an “Adobe Acrobat” platform or any other suitable platform as recognized by one having ordinary skill in the art. In one embodiment, the server 102 may be installed in an “IBM Web Sphere Application Server,” which is coupled to an “IBM HTTP Server” 106 via any suitable internet or other communication channel 108, wherein the IBM Web Sphere Application Server and the IBM HTTP Server are available from I.B.M. Corp., Armonk, N.Y.

In greater detail, the Designer 100 contains self activating software which is responsive to user input data at 110, and which may be transmitted over an internet, other access path or link 112. The user input data 110 designates such things as marketing, actuaries information, the design of appropriate forms and procedures. The Designer 100 provides supplemental information and collates it with the user supplied data in order to assemble a transactional report including an instructional output as well as, in one embodiment, a form having various data entry fields. The Designer 100 implements the instructional output by creating appropriate commands or instructions in any suitable computer readable computer language to be followed by server 102. These instructions relate to such thing as: the design of transactional forms, documents, statements, summaries and reports; to provide for editing and calculating and to provide work rules for the proper flow of data.

The server 102 is responsive to the computer language of the instructional output within the transactional report created by the Designer and has several direct access memory storage areas 114, 116 which pre-store both a database of information and a protocol for providing assistance for business or other appropriate needs. In one embodiment, memory 114 is a read only memory and memory 116 is an interactive memory.

Among other things, the database having pre-stored data at 114 contains definitions of application and transactional information along with templates that enable a readout of organizational data in an orderly form. The storage areas in memory 114 also contain operational code including instructions for making edits and calculations and for supplying work flow rules and a database schema.

A program generating circuit 117 includes the application repository memory 116 which retains archived data relating to the history of documents and to customer information, both current and historical, as well as to scheduled or future events and user tasks.

An administrative protocol area 118 in the server 102 contains a program for organizing and collating data received from the user as modified by the Designer 100 and the pre-stored data read out from the direct access memory 114. As recognized by one having ordinary skill in the art, the program in the administrative protocol area 118 may be encoded in any suitable computer-readable program code. As historic or customer information is utilized, the direct access memory repository 116 is accessed and interrogated. For example, the stored memory 116 may include the customer history, name, address, subject matter, descriptions, phrases, unpaid account balances, customer credit ratings, and any other suitable information, as recognized by one having ordinary skill in the art.

A customer self-service protocol area 120 of the server 102 assembles everything described thus far into a suitable output form which is then forwarded to an IBM HTTP server 106 in order to provide information which may be used to present a document to the customer or other end users. The document may include such things as web pages, forms and the like—delivered in any suitable format to the end user at 122 via internet 124 or any other suitable transmission path.

The operation of the inventive system is described by using an example of a business or financial institute which buys and sells shares in any one of many different mutual funds, although the example could as well be a document relating to any different business applications.

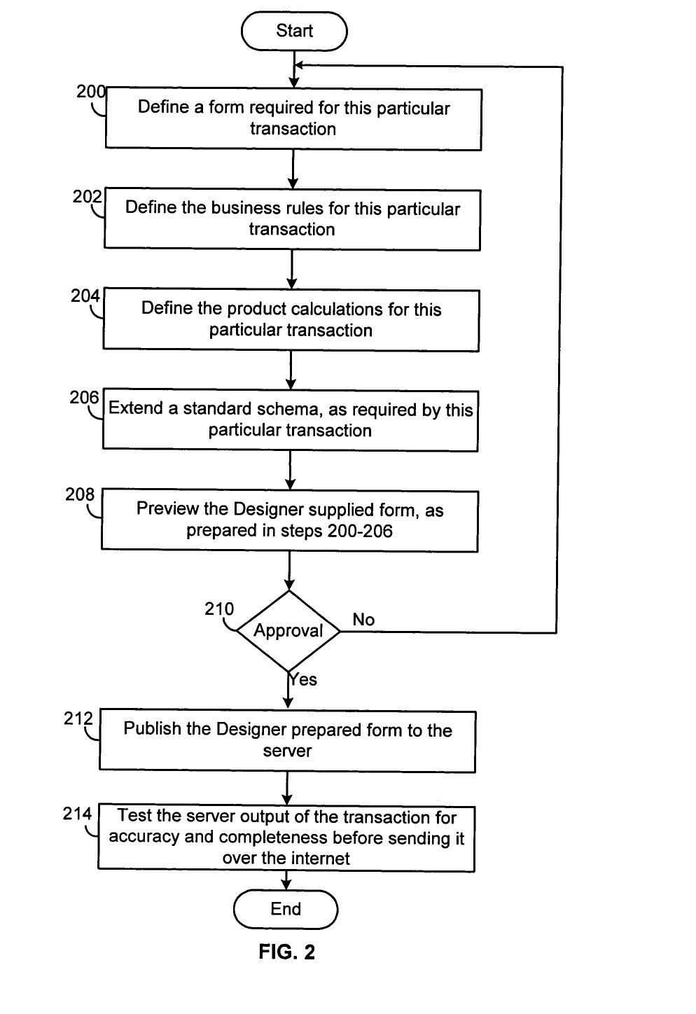

The input end user having access to input module 110 carries out the steps described below for creating a document, as shown in the flowchart of FIG. 2. The first step 200 is defining a form required for this particular transaction.

The next step, 202, is defining the business rules for this particular transaction. The step 202 of defining the business rules might be establishing maximum or minimum amounts allowed for a single transaction, checking a customer's credit rating or an amount on deposit with a broker, calling out the buy/sell rules of a particular mutual fund, the minimum or maximum administration costs permitted per transaction, or any other suitable rule as recognized by one having ordinary skill in the art.

Thereupon, the next step, 204, is defining the product calculations for this particular transaction. The step 204 of defining the product calculation may be something as simple as multiplying the pertinent number of shares being bought or sold by the present price per share. Of course, any specific transactions may also require any one of a great variety of different calculations.

Step 206 provides for extending a standard schema, as required by this particular transaction. This step 206 interrogates any suitable database for such things as: a customer's address, deposit account balance, present price per share, number of shares available, information about return on investment, or any other suitable data field as recognized by one having ordinary skill in the art. Whereupon steps 200-206 result in the production of properly formatted software.

The next step, step 208, is to preview the Designer supplied form. This step 208 calls for the person using the system to preview information in the formatted form to validate and approve all that the Designer has done in steps 200-206 in order to insure the accuracy and acceptance of the entered instructions and/or data. The function of the Designer is now to present the command and instructions to the server in a form that it can use.

If the form is not approved, step 210, the process may start over at step 200. Otherwise, upon approval, the next step 212 is to publish the Designer prepared form to the server. Step 212 transfers the Designer's instructions to the server 102. The server 102 collates and assembles the instructions received from the Designer 100 with data taken from memories 114, 116 in order to provide computer command signals and send them over link 108 to the suitable http server 106 and on to the addressee at the end user 122 position.

Thereupon, the final step, step 214, is to test the server output of the transaction for accuracy and completeness before sending it over the internet. As such, one embodiment of the present invention is complete.

For an exemplary transaction of buying shares in a designated mutual fund, a menu appears on the left side of a computer monitor screen at input 110 in order to enable the user to define tasks. The user highlights a prompt in the menu to identify a particular fund. An appropriate form appears on the right hand side of screen. Next, a prompt might be highlighted to request a transfer of funds from a deposit account to a buy account. Or, perhaps, a particular customer might have a different arrangement for paying for the purchase, in which case, that form of a prompt might appear.

For example, the customer might have specified that his deposit account must never be drawn down below $1000. If so, the Designer might reject a request to withdraw funds from a deposit account if it draws down the account under the $1000 level.

Assuming that a withdrawal of funds from a deposit account is appropriate for this transaction, an amount is entered on the form displayed on the monitor. The Designer goes through the defined calculations of step 206 and accepts or rejects the requested payment or withdrawal at step 206. In one embodiment, the acceptance or rejection may be made on a basis of funds available or customer's credit rating.

Next, the user enters any specific information on the form, such as the maximum or minimum amount per share that the customer has authorized for a purchase or sale of shares in the fund. Again, the computer goes through the prescribed calculations described in step 204, as necessary.

Assuming that everything is in order, the next prompt calls for the name of the payee for the purchase of the mutual shares. After all of the necessary information is entered on the form, it is displayed for a preview by the user. If acceptable, a suitable identification is entered on the form such as the date, a transaction number, and the like.

At this point a portfolio summary is displayed showing the customer's positions after the transactions are completed.

If all is well, the Designer 100 exports its stored data to the server 102 which collates the data with the data stored in the server to prepare a transactional report to the customer. After the server completes its preparation, the transactional report is sent over the internet 108, 124 to the customer at the end user 122 position.

The present invention provides for a solution built on a platform that is extendible by the end user. This means the documents, user interface, database definition, procedures and processing logic can be modified without an undue amount of technical expertise or special programming training. Moreover, the product definition is built into and within the input (request) documents and the resulting output documents. All edits, calculations, accounting, time driven processing, data requirements, etc. are self contained within these crated transaction documents. Furthermore, the user interface is document centric. If the user understands how to fill out printed paper forms, that is all that is needed. This eliminates errors and training associated with re-keying data from a form into a user interface that may or may not resemble that form, and allows the user interface to customized the system to fit the product and its documents, instead of requiring a customization of the product and its documents in order to fit the system.

Those who are skilled in the act will readily perceive various modifications. Therefore the appended claims are to be construed to cover all equivalents which fall within the scope and spirit of the invention.

1. A self-programming method of creating records of a transaction, the method comprising the steps of:
receiving user input data from a user input device;
executing first software instructions such that a Designer implements the user input data, the Designer including supplemental instructions stored therein for use in connection with the user input data;
collating the user input data with the supplemental instructions for creating a transactional report;
transmitting the transactional report to a server, wherein the server includes at least one direct access memory for pre-storing data;
executing second software instructions such that the server collates the collated instructions with data pre-stored in the server in order to generate a final report; and
transmitting the final report to an end user device.

2. The method of claim 1 wherein the first software instructions carry out the steps of:
(1) defining a form appropriate for the transaction;
(2) defining business rules for the transaction;
(3) defining product calculations for the transaction;
(4) extending a schema to fit the transaction; and
(5) allowing for the previewing of the form as prepared during steps (1-4).

3. The method of claim 2 wherein the second software instructions test the final data for accuracy and completeness before transmitting it to the end user device.

4. The method of claim 1 wherein the Designer is adapted to receive marketing, actuaries, form design, and procedure design supplied by the human input data instructions.

5. The method of claim 1 wherein the first software instructions include a capability for designing transaction forms and documents, statements, summaries and reports, and instructions for providing editing and calculating, and work flow rules.

6. The method of claim 1 wherein the at least one direct access memory stores data relating to an application definition, a transaction definition, document templates, editing and calculating, work flow rules and database schema.

7. The method of claim 1 wherein the at least one direct access memory stores data relating to a document history, customer history, current customer state, future events, and user tasks.

8. A data processing method for causing a computer to produce a document relating to a specific transaction, the method comprising:
receiving user input data supplied by an end user from a user input device, the user input data received in a Designer having first data relating to the creation of a computer usable program stored therein;
generating a transactional report for use by a server, wherein the transactional report is generated using the user input data and the first data;
transferring the transactional report to the server, wherein the server includes an administration protocol and includes second data relating to specific customer information stored therein;
preparing the computer usable program utilizing the transactional report and the administrative protocol;
collating and assembling information in the transactional report with administrative protocol data and the second data;
arranging the collated and assembled information for providing a final report; and
providing the final report to an end user device.

9. The method of claim 8 further comprising:
displaying a preview of an output form for the transactional report; and
providing for editing of the output form; and
providing for approval of the output form prior to be transferred to the server.

10. The method of claim 8 wherein the transactional report generated by the Designer is formed responsive to the initial steps including defining a form, defining work flow rules, defining product calculation and interrogating a database.

11. The method of claim 10 further comprising:
selecting a subject matter relating to the specific transaction, thereby identifying at least one of an institution, business, fund or organization.

12. The method of claim 11 wherein the input data includes a name of a financial entity, an amount of money involved in the specific transaction, and details of a specific transaction.

13. The method of claim 8 wherein the specific transaction involves a buy/sell order and the initial steps include identifying a specific customer, selecting a financial entity, entry of a number of units bought/sold, and calculating a total price of the units bought/sold.

14. The method of claim 13 further comprising:
deciding whether to approve or refuse the buy/sell order.

15. The method of claim 8 further comprising:
verifying that the specific transaction is within parameters of the first data and the second data.

16. The method of claim 8 further comprising:
defining a payee of any checks or money transfers generated by an approved transaction.

17. The method of claim 8 further comprising:
identifying a specific customer who provided the input data and requiring the specific customer to authorize a final transaction before completion of the specific transaction.

18. An apparatus for processing and documenting transactional information, the transactional information relating to any one of many different businesses, the apparatus comprising:
an input device capable of receiving a user to input data for processing and documenting the transaction;
a Designer operably coupled to receive the user input data from the input device, the Designer supplying a form responsive to the user input data and generating a program responsive to the user input data, the program providing at least one document selected from a group consisting of statements, summaries, and reports relating to the transaction, for implementing and editing of the selected document, for implementing calculations, and for implementing work flow rules;
a server operably coupled to the Designer, wherein the server responds to the generated program to generate a document;
a first memory associated with the server for providing archived matter, the first memory being a repository of pre-stored information for carrying out the generated program, the repository including application definitions, transition definitions, document templates, edits and calculations, work flow rules, and a database schema;
a second memory associated with the server, the second memory having a repository for receiving input data and for outputting processed data, the repository including a document history, a customer history, a file of current customer state, a file of future events, and a file of user tasks; and
a device for transmitting the document as prepared jointly by the Designer and the server over the internet.

19. The apparatus of claim 18 further comprising:
a device inter-coupling the Designer and the server, the inter-coupling device comprising a first unit for providing administrative tasks and a second unit for providing customer self-service, the first and second units being responsive to the Designer and to the first and second memories;
the first unit providing program instructions for handling phone inquiries and transactions, entering data relating to the transactions, auditing customer accounts, verifying and approving transactions, and managing internal work flow; and
the second unit providing program instructions for checking account status, requesting statements, reprinting statements, reviewing transactional history, perform transactions, and scheduling future events.

20. An apparatus for processing transactional information, the apparatus comprising:
a device for receiving user input data relating to a transaction;
a Designer responsive to the user input data for assembling instructions for creating a pre-program;
at least a first memory providing a repository of first pre-stored data relating to details of how a program is formed;
at least a second memory providing a repository of second pre-stored data relating to details of a possible transaction;
a program generating circuit including an administrative task protocol responsive to the Designer and the memories according to the first and second pre-stored data; and
the program generating circuit also including a customer self-service protocol for converting operations of the Designer, memories, and program generating circuit administrative task protocol into a computer usable message and transmitting the computer usable message over an internet to an end user.
